(19) United States
(12) Patent Application Publication
(10) Pub. No.: US 2003/0169294 A1
(43) Pub. Date: Sep. 11, 2003

(54) Method and device for providing a representation of applications for display on an electronic device

(75) Inventors: Veli-Pekka Vatula, Nokia (FI); Jyrki Iivainen, Nokia (FI)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/383,828

(22) Filed: Mar. 7, 2003

(30) Foreign Application Priority Data
Mar. 8, 2002 (WO) PCT/IB02/00691

(51) Int. Cl. G09G 5/00

(52) U.S. Cl. 345/764

(57) ABSTRACT

In accordance with this invention, there is disclosed a method for providing a representation of a first application to be executed in an electronic device that uses the representation to present information of at least one other application that selects one of the applications for direct display and selects at least another of the applications for indirect display in accordance with information representative of a state of at least one of the applications. Further, a user interface and an electronic device are disclosed having a display and being adapted to operate a plurality of applications having a component for providing a representation of one of the applications, a component for using the representation to present information of at least one other of the applications, and a component for selecting one of the applications for direct display and selecting at least another of the applications for indirect display in accordance with information representative of a state of at least one of the applications.

### CROSS REFERENCE TO RELATED APPLICATIONS

This application claims priority under 35 USC §119 to International Patent Application No. PCT/IB02/00691 having an international filing date of Mar. 8, 2002.

### TECHNICAL FIELD

The present invention relates to graphical representations of applications in graphical user interfaces of electronic devices. It also relates to taskbar applications of computer programs using buttons and notification areas providing information and shortcuts to active applications on an electronic device. The present invention in particular relates to a method and a device capable of saving display space of a display in an electronic device by providing the information with a minimized requirement of display area and a maximum of provided information.

### BACKGROUND OF THE INVENTION

The taskbar, notification areas, buttons and menus are described in United States patents U.S. Pat. No. 5,757,371 and U.S. Pat. No. 5,617,526 both by Oran et al. and both assigned to Microsoft Corporation, Redmond, Wash.

The document U.S. Pat. No. 5,757,371 describes a taskbar with a start menu and buttons with the options to start or display windows of active applications by input via a cursor controlled by a mouse. This feature is well known to those skilled in the art from computer programs like Windows NT, Windows 95 and the following versions.

The document U.S. Pat. No. 5,617,526 describes a taskbar with a start menu with the options to start or display windows of active applications. This feature is well known to those skilled in the art from computer programs like Windows 95 and the following versions.

Presently, the taskbar of the Windows program shows buttons for all active (open) applications windows during the use of a computer. The taskbar notification area shows icons for those applications that are also active but do not have any windows open at the working area (e.g. volume controller, anti-virus programs etc.). In the following, applications with no open windows are referred to as “background applications”. In the notification area, information can be presented to the user by use of different icons (for example in the form of a letter when new email has arrived etc.). In Windows OS (operating system) the notification area is formed so that it reserves only the needed area for displaying the icons of the background applications and expands when it needs more space. However, this narrows the remaining area needed for active window buttons. This area is easily filled by buttons, e.g. by using internet browsers or “my computer” applications. All active windows open new buttons in the taskbar and when the number of buttons increases, the size of the buttons correspondingly must decrease. This leads eventually to a situation where there are many small buttons in the taskbar and it is impossible to say which is which. When browsing the internet, the browser can open a new window. Many web-sites have links that open up in a new window, but more common are links that only change a page in a window that is already open. In addition the browser may open a window for each activated Hyperlink, so that in an internet session e.g. 6 or more browser buttons are opened.

The state of the art is further hampered from the fact that the taskbar and the buttons consume a space on the display. For conventional personal computers with big displays this is not a problem, as e.g. the space required for a taskbar on a 21-inch monitor is nearly negligible. For portable computers such as e.g. laptops, palmtops, PDAs or communicators, the space required for the taskbar, the buttons and notification area is limited. On a 12 cm wide display only ten buttons limit the space for a single button to 1 cm, a space too small for adequate information of the single application. In the case of PDAs with only a 7 cm wide display, the provided space is only enough to display a start menu button, a single standard Windows application button and only a single notification.

Both documents cited above have in common that they are not suitable for use with mobile devices, such as mobile phones or handheld computers, due to small displays. Therefore, a method is needed that provides information to a user without wasting too much display area. The standard option to save display space according to the state of the art, to hide the taskbar, is hampered by the drawback that notifications from background applications are not visible even if the notification is important. The hiding option cannot provide more information for each icon. The option to increase the size of the taskbar to be able to display bigger buttons and notifications has the drawback that this wastes display area, if only a few applications are running.

### SUMMARY OF THE INVENTION

So it is desirable to provide a method and a device that enables a user to inform himself of active applications in a taskbar without requiring much space of the display. It is further desirable to provide notifications of background applications and to visualize background applications for a user with a minimized display space required.

In accordance with a first aspect of the present invention there is provided a method for providing a representation of a first application to be executed in an electronic device, comprising: using this representation to present information of at least one other application; and selecting one of the applications for direct display and selecting at least another of the applications for indirect display in accordance with information representative of a state of at least one of the applications.

With this method one and the same representation is used for providing a representation of a first application and at least one other application, thereby providing and preferably displaying a representation of at least two applications. Hence the necessary display space is considerably reduced with implementing the invention, thereby saving display space of a display in an electronic device.

By selecting an application it can be decided if an application is important enough or adapted for being displayed. By providing a representation of the at least two applications in accordance with information representative of a state of at least one application or in accordance with indications thereof, information can be provided to the user. The representation can be e.g. a tray area containing e.g. icons of the selected applications. In this representation, the applications selected for direct display can be represented by an icon and or a text element in a button or a notification area. In this representation, the applications selected for indirect display can be represented by an indication element or e.g. pop-up menu with text elements and/or icons. So the representation may comprise a direct display element associated with the application(s) selected for direct display and an indirect display element associated with the application(s) selected for indirect display.

According to a second aspect of the present invention which may be provided as an independent solution or as a preferred embodiment of the first aspect, there is provided a method for displaying a representation of at least one application to be executed in an electronic device, comprising the steps of: displaying a representation of one application; and using the same representation to present information of at least one other application.

With this method according the second aspect, one and the same representation is used for indicating or displaying one application and at least one other application, thereby displaying a representation of at least two applications. Hence the necessary display space is considerably reduced with implementing the invention, thereby saving display space of a display in an electronic device.

In accordance with a third aspect of the present invention, which may be provided as an independent solution or as a preferred embodiment of one of the first and the second aspects of the invention, there is provided a method comprising two steps, preferably to be executed prior to the step of displaying a representation, comprising the steps of receiving at least an indication, e.g. message, notification or other indication from or of at least two applications, that indication(s) comprising information representative of a state of at least one application, and providing a representation of the at least two applications for display, according to the information representative of a state of at least one application. The step of providing may comprise a generating step or may be comprised in a general retrieving procedure if the representation and/or interface element has already been generated and is only retrieved from a memory. By providing the representation, any kind of application producing this representation is encompassed.

By receiving the indication or indications, it can be determined which application is actually active; and it can be determined if, e.g., the application has an open window or requires to notify the user of events such as a received email. By providing a representation of at least two applications, information about both applications, preferably in a common representation, can be provided to the user. The method can be executed initially when starting a computer. The method can be repeated in accordance with the received indications, so that the provision of the representation is updated if e.g. a message from a new application is received or if the state of an application has changed recently.

Advantageously and in combination with any one of the aforementioned first, second or third aspects of the invention, the selecting step comprises prioritizing the at least two applications in an order in accordance with the information representative of a state of at least one application. By prioritizing the applications, the applications can be sorted according to the received application data. The applications can be prioritized according to different priority schemes, such as the actual resource consumption, an amount of data to be processed, actually consumed CPU (Central Processing Unit) time, the level of data in a data queue and the like. The priority of the applications can be determined by e.g. analyzing the received application state related data, or data from a task manager application, or from a number of detected user interactions. The prioritizing will result in a linear order of the applications.

Conveniently, the step of prioritizing is executed in accordance with previously stored application priority data. To prioritize the applications according to the application priority data, the data have to be retrieved e.g. from a memory. The application priority data can be a set of default data or can be selected by a user.

Advantageously, the applications are selected from a determined level of priority. So the method can select e.g. only the application with the highest priority. The level of priority can be a fixed threshold level such that all applications below the predetermined level are not selected. The level can be determined or changed in dependence of other conditions such as a maximum number of selectable applications or a minimum number of applications to be selected. The algorithm for determining the priority level can be any other arbitrary level selection algorithm.

Conveniently, this method further comprises a step of requesting an indication or indications comprising information representative of a state of at least one application, preferably executed prior to the step of receiving the indications. By requesting indications, the method can actively retrieve the application state related data, and does not need to wait for the unrequested transmission of information from applications. So an application using this method can request information from applications and refresh its selection and display periodically.

Preferably, after the step of providing or generating the representation, or after the step of selecting the application for display, a step of displaying the at least one representation is carried out which may further comprise a step of sorting the representations in accordance with the information representative of a state of at least one application. By sorting the representations, buttons and notifications can be sorted to a taskbar and to a notification area or tray application. The representations, e.g. buttons and notifications, can be sorted in accordance with their priorities.

Conveniently, this method is executed without substantially interrupting the running of the application program. By not substantially interrupting other applications it can be assured that the overall performance of the electronic device is kept high, as perceived from a user. Hence, a data transmission will not have to be interrupted for executing the method. The method is not very time sensitive, as it aims to inform a user, and therefore a delay below e.g. one second will not even be perceived by a user.

Preferably, the method further comprises a step of providing these representations as a signal to be displayed. The signal can be a code or code sequence transferred e.g. to a display, a display interface, a display driver, or the COM server of an electronic device.

Advantageously, the method further comprises the step of displaying the representation as a user interface element. The element may be displayed on a visual display as a LCD (Liquid Crystal Display), a monitor, or any other device capable of displaying.

Preferably a plurality of representations are displayed in one common user interface element. The user interface element can be a standard user interface element such as an application window, a tray, a button, a notification or the like. The displayed user interface element can comprise at least one icon associated to the application selected for direct display. The user interface element can comprise a text related to the application selected for direct display.

Preferably the displayed user interface comprises an indication element for indicating applications selected for direct or indirect display, so that a user can recognize that there are other applications running. The displayed user interface can comprise buttons for opening a window of the application by user input. The displayed user interface may comprise a tray to indicate that the representations in the tray are associated with each other. The association can indicate that the representations are of the same kind or belong to the same type of application.

Advantageously, the user interface is composed of sub-elements; so an icon can be retrieved from an icon library and be composed with a background element indicating that there are other active applications which are not depicted.

Preferably the method comprises the step of composing a plurality of representations into one user interface element, a so-called composite interface element which comprises parts, with each part thereof representing a certain application, whether active or not. So preferably a composite user interface element is provided having components for indicating an application being destined for direct display and having components for indicating an application for indirect display.

Preferably, this method is executed by a tray application. By using a tray application, the implementation of the method can be simplified. A tray application can present a single tray icon if no other applications are active. The tray application can use a tray application interface to enable a user to customize the settings, priorities and the graphic presentation of the representations or user interfaces. The tray application interface can be e.g. a pop-up menu or a tray application window. The tray application can work independently or with other programs to achieve results depending on the operating system it is used with. The tray application can be an applet to e.g. a standard taskbar application or can be an autonomous application.

Preferably, the method further comprises the steps of receiving a user input related to the displayed user interface and displaying representations of all preferably active applications according to the priorities of the application states. This enables the method to display all applications on demand, so that not only the selected applications are displayed but also the representations of non-selected applications can be displayed to the user. The user input can be a sequence of key presses or positioning a cursor over on the user interface and pressing a key of an input device (a mouse button or the like). According to one embodiment this can be implemented as a pop-up list comprising all the applications (selected and not selected) so that a user can simply see all active applications. Hence, to see the application list, a user may e.g. use the right mouse key, and to start or visualize an application the user may e.g. release the key or use the left key with an item of the list.

Advantageously, the method further comprises the step of receiving an input related to the displayed representation of an application or just an indication or element thereof, and depicting an application user interface of the application in response. The application user interface can be an application window.

Advantageously, the method further comprises receiving an input related to the displayed user interface, and depicting context sensitive items in response. This option can be used to provide a tool tip functionality to display context related information such as a short explanatory text of the properties of the application related to the displayed user interface, or the graphic elements in the user interface, such as names of files used, or the network address a browser is connected to. The explanatory text can contain a hint of a shortcut to open a window of the application or the like. The context-sensitive items can be comprised in a pop-up menu also containing a list comprising actually non-represented applications. A pop-up menu can contain a prioritized list of all active applications and context related information.

Preferably there is provided a method changing the display of representation of an application to the display of representation of another application upon receiving an input related to the representation of the application. Thereby the user can directly switch from the representation of one application to another one upon pushing an input related to the first application.

According to another aspect of the present invention, a software tool for displaying representations of applications (programs) on an electronic device is provided. The software tool comprises program code means for performing all of the steps of the methods described in the preceding description, when the program is run on a computer or a network device. The software tool can be an applet implemented in a computer program.

According to another aspect of the present invention, a computer program for carrying out the method for providing representations of applications on an electronic device is provided, which comprises program code means for performing all of the steps of the preceding method when the program is run on a computer or a network device.

According to yet another aspect of the invention, a computer program product is provided comprising program code means stored on a computer readable medium for carrying out the method for providing and/or displaying representations of application programs on an electronic device, when the program product is run on a computer or a network device.

According to another aspect of the present invention a user interface is provided for displaying applications on a display of an electronic device, the display being adapted to display a representation of a first application to be executed in the electronic device, wherein the representation is used to present information of at least one other application; and one of the applications is selected for direct display and at least another one of the applications is selected for indirect display in accordance with information representative of a state of at least one of the applications.

Preferably this user interface comprises a selection that prioritizes the at least two applications in an order in accordance with information representative of a state of at least one of the applications

In accordance with another aspect of the invention, there is provided a user interface for displaying or at least providing representations of applications, thereby saving display space of a display in an electronic device, the display being adapted to display at least one representation of at least one application to be executed in the electronic device, wherein the at least one representation is so formed as to comprise more than one application. The user interface hence comprises representations of at least one application and preferably an element indicating actually not directly displayed applications.

The user interface preferably comprises a representation comprising a sequence of applications which is prioritized in an order. Preferably the user interface has a representation which is a signal to be displayed. In an alternative embodiment the user interface comprises a display for displaying the representation.

Preferably the user interface comprises a plurality of representations to be displayed, wherein the representation may comprise a user interface element.

Preferably the displayed user interface element comprises at least one icon associated with applications, or comprises an element indicating at least one application. The user interface element may comprise a button, a tray, or is composed of a plurality of representations. Preferably the user interface element is a composite representation of a plurality of applications displayed in a common symbol or icon or button or tray.

The user interface can be a single icon or it can be composed of an application icon with an indication element. The user interface can be composed of more than one icon and an indication element, wherein the icons can be sorted according to their priorities. The user interface can be a tray icon comprising a representation of a single application and a graphical element indicating the presence of non-visible applications. The user interface element can be a button with an indication element.

According to yet another aspect of the present invention, an electronic device, e.g. a mobile terminal device preferably capable of executing the above-mentioned methods, is provided comprising:

a component for providing a representation of one of the applications;

a component for using the representation to present information of at least one other of the applications;

a component for selecting one of the applications for direct display and selecting at least another one of the applications for indirect display in accordance with information representative of a state of at least one of the applications.

Preferably, there is further provided a component for prioritizing at least two applications in an order in accordance with information representative of a state of at least one of the applications.

In accordance with yet another aspect of this invention, there is provided an electronic device having a display being adapted to run a plurality of applications. The electronic device further comprises a component to receive indications of applications or information related to the state of at least two applications on the electronic device, and a component to provide or generate and preferably display a representation of the at least two applications in accordance with the information representative of a state of at least one application and preferably with the priorities of the applications on the display. The components can be e.g. embodied as program code sections running on the electronic device.

Preferably, the electronic device further comprises a component to select at least one of the at least two applications for direct display and the non-selected application(s) for indirect display, accordance with the obtained information representative of a state of at least one application.

Preferably, the electronic device further comprises an input device, and a component to display the generated representation as a user interface element. Preferably there is also provided a component to activate an application by user input in response or relation to the interface element.

### BRIEF DESCRIPTION OF THE DRAWINGS

In the following, the invention will be described in detail by referring to the enclosed drawings in which:

FIG. 1 is a flowchart of the method according to one embodiment of the present invention;

FIG. 2 is an example of an implementation of the method as software;

FIG. 3 displays an example of a graphical representation of a tray application; and

FIG. 4 depicts different embodiments of buttons and icons that can be used for the graphical representation of selected applications.

### DETAILED DESCRIPTION

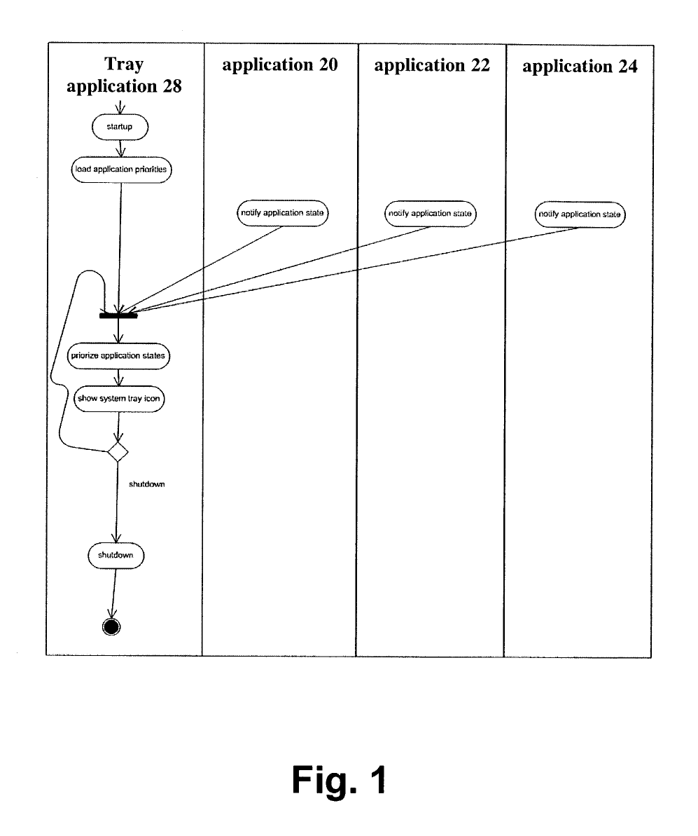

FIG. 1 depicts a flowchart according to one embodiment of the present invention. The flowchart depicts four applications, i.e. the tray application 28, and other applications 20, 22, 24. These applications can be arbitrary applications like an internet browser, a data layer monitor, a media monitor or any other application.

In the first step the tray application 28 is started during the start-up of the electronic device. In the next step the tray application 28 loads previously stored application priorities from a memory. Next the tray application 28 receives application state information from the other applications 20, 22, 24. In the following step the application states are prioritized in accordance with the previously loaded application priorities. Following that, an icon of the tray application 28 is displayed. The displayed tray icon can comprise the icon of the application with the highest priority. The steps of receiving, prioritizing and displaying are repeated until shutdown. The period of the repeating can be fixed, or the repetition is executed when e.g. an information is received.

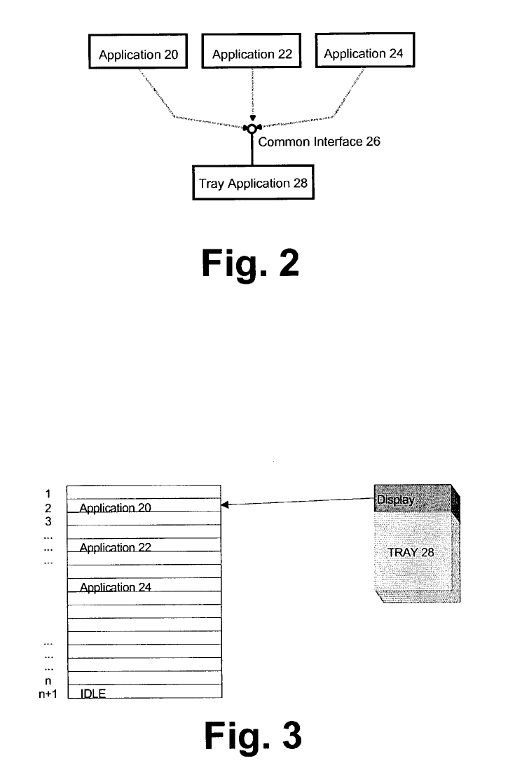

FIG. 2 is an example of an implementation of the method as a computer implemented software. The basic idea in this embodiment is to use a common or composite component creating a tray icon. All applications needing to present information on the tray use a common interface 26, offered by the common tray application 28 (which later in this application with common interface 26 is just called tray 28). The best way of implementing this in e.g. a Windows environment is a stand-alone COM Server. The tray application 28 is an out-of-process COM-server application, which is used to show the status of computer applications 20, 22, 24 and to allow the end-user to open windows for the computer applications 20, 22, 24. Status information is shown visually as a system tray icon in a task bar and textually as the icon's tool-tip text (not shown). The system tray application can be activated when an end-user logs in.

FIG. 3 displays an example of a graphical representation of a tray application, wherein the tray 28 is made of a priority stack according to which the icon on the tray is shown. The priority stack is shown on the right side with a line numbering 1, 2, 3, . . . n,n+1. The lowest priority n+1 belongs to the tray application icon. If there are no applications requesting information to be displayed in the tray, a default icon (IDLE n+1) is shown. In the depicted embodiment the priority stack has n+1 lines for possible applications (or application states). This stack can be previously stored and be loaded by the tray application 28 after the start-up (see FIG. 1). The states of the application 20 are assigned with the priority 2, wherein the priorities of the applications 22 and 24 are lower. The tray application 28 selects the active application with the highest priority (application 20) to be displayed. The other applications 22, 24 are not displayed.

This invention presents a solution of how a taskbar and a notification area can be used with optimized maximum visibility. An operating system of an electronic device opens an icon to the notification area. An electronic device however does not use one single application, but a collection of several applications; therefore it needs to use one icon to present information from several applications. This is solved by a special tray application that decides which application gets visibility at any time. This idea can be expanded also to window buttons that are in the taskbar. Instead of opening a new button for a new window if an application already is in use (for example Internet Explorer), the tray application adds information to the same button.

This invention simplifies the taskbar and makes it more versatile to use. Instead of having several buttons for each browser window, all information is behind one button. If a user wants to change the window, the only thing he needs to do is click a browser button with the mouse's right button or with a similar input method and choose the wanted window from a list that is presented. All the normal information is still in this right-click menu and window list and other wanted properties are added on top of that. The tray application can also be used to activate buttons to inform the user of some situation which needs feedback or just to inform the user that something has happened. It is also possible to group some applications so that they use only one button instead of a separate button for each. If needed, these buttons can use some basic activities such as “open file” etc. In this way more information can be presented to the user and the taskbar can be modified to meet the requirements of a user.

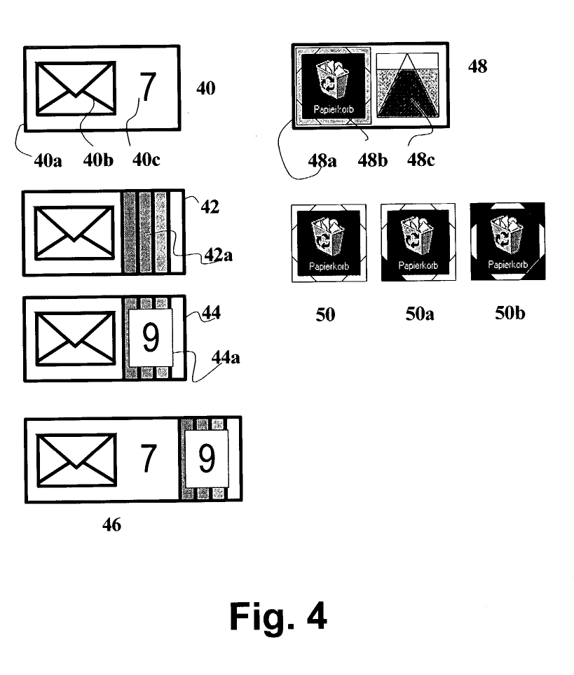

FIG. 4 depicts different embodiments of buttons and icons that can be used for the graphical representation of selected applications. In the figure, the number 40 refers to a graphical representation according to one embodiment of the present invention. The graphical representation comprises a tray icon 40a, an application icon 40b and an indication 40c of non-visible applications. The graphical representation 40a defines e.g. a notification area or the tray application icon. The icon 40b indicates a notification “you've got mail” or an active mail application program. The indication element 40c notifies the user that there are seven application programs active, that there are seven mail applications active, or that there is one mail application active, having received seven mails and no other applications active.

Reference number 42 refers to another embodiment of a representation of a tray application icon. As in the case of the representation 40, the tray icon indicates the presence of actually non-visible applications by the columns 42a. The number of visible columns 42a can be related to the number of “invisible” applications. Preferably the number of invisible applications can be indicated as a number icon as depicted in the representation 44 as the number “9” designated with the reference number 44a. The tray icon 46 combines the properties of the icons 40 to 44, the application icon is combined with a tray icon and two indicative elements, wherein e.g. the “7” indicates the presence of seven mails or mail applications, and the “9” indicates that nine further applications are actually non-visible. The graphical representations or user interface elements 40 to 46 can be buttons too, wherein the graphic elements 40c, 42a, 44a, can indicate the number of similar active applications.

Number 48 depicts a tray icon 48a with an application icon 48b and a graphical element 48c indicating the number of hidden applications by the level of the grey rectangle.

The icon 50 is a composite icon with an application icon and a frame element indicating that the actual application is the only one actually active. The frame of icon 50a indicates one hidden active application by the black bottom left corner. The frame of icon 50b indicates four hidden active applications by the four black corners.

It is to be noted that the electronic device can be a computer, a personal computer, a portable computer, such as a laptop, a notebook, a palmtop or a PDA (Personal Digital Assistant). The electronic device can be a mobile telephone or a mobile communicator.

This application contains the description of implementations and embodiments of the present invention with the help of examples. It will be appreciated by a person skilled in the art that the present invention is not restricted to details of the embodiments presented above, and that the invention can also be implemented in another form without deviating from the characteristics of the invention. The embodiments presented above should be considered illustrative, but not restricting. Thus the possibilities of implementing and using the invention are only restricted by the enclosed claims. Consequently, various options of implementing the invention as determined by the claims, including equivalent implementations, also belong to the scope of the invention.

What is claimed is:

1. A method for providing a representation of a first application to be executed in an electronic device, comprising:
using said representation to present information of at least one other application;
selecting one of said applications for direct display and selecting at least another of said applications for indirect display in accordance with information representative of a state of at least one of said applications.

2. A method according to claim 1, wherein said selecting comprises prioritizing said at least two applications in an order in accordance with information representative of a state of at least one of said applications.

3. A method according to claim 1, wherein using the same representation comprises the following:
receiving an indication of at least one application, said indication comprising information representative of a state of at least one of said applications; and
providing a representation of said application for display, according to said information representative of a state of at least one of said applications.

4. A method according to claim 2, wherein said prioritizing is executed in accordance with previously stored application priority data.

5. A method according to claim 1, wherein said applications are selected only from a determined level of priority.

6. A method according to claim 3, wherein said method further comprises a request of indication comprising information representative of a state of at least one of said applications, to be executed prior to receiving said indication.

7. A method according to claim 1, further comprising providing said representation as a signal to be displayed.

8. A method according to claim 1, further comprising displaying said provided representation.

9. A method according to claim 1, further comprising sorting a plurality of representations in accordance with said information representative of a state of at least one application.

10. A method according to claim 1, wherein said method is executed without substantially interrupting the operation of an application.

11. A method according to claim 8, wherein said representation comprises a user interface element.

12. A method according to claim 11, wherein said displayed user interface element comprises at least one icon associated with said application(s) selected for direct display.

13. A method according to claim 11, wherein said displayed user interface element comprises an element indicating an application(s) selected for indirect display.

14. A method according to claim 11, wherein said displayed user interface element comprises a button.

15. A method according to claim 11, wherein said displayed user interface element comprises a tray.

16. A method according to claim 11, further comprising providing the user interface element by composing a plurality of representations.

17. A method according to claim 1, wherein said method is executed by a tray application.

18. A method according to claim 11, further comprising receiving a user input related to said displayed user interface element, and displaying representations of all applications according to priorities obtained by prioritizing the applications.

19. A method according to claim 18, further comprising receiving an input related to one of said displayed representations of applications and depicting an application user interface element of said application in response.

20. A method according to claim 1, further comprising receiving a user input related to the displayed representation and depicting context sensitive items in response.

21. A method according to claim 1, further comprising changing the display of representation of an application to the display of representation of another application upon receiving a user input related to the representation of said application.

22. A software tool for providing representations of applications on an electronic device, comprising program code for executing the method of claim 1 when said program is run on a computer or a network device.

23. A computer program for providing representations of applications on an electronic device, comprising program code for executing the method of claim 1 when said program is run on a computer or a network device.

24. A computer program product comprising program code stored on a computer readable medium, said program code for executing the method of claim 1 when said program product is run on a computer or network device.

25. A user interface for displaying applications on a display of an electronic device, said display being adapted to display a representation of a first application to be executed in said electronic device, wherein:
said representation is used to present information of at least one other application; and wherein
one of said applications is selected for direct display and at least another of said applications is selected for indirect display in accordance with information representative of a state of at least one of said applications.

26. A user interface according to claim 25, wherein said selecting comprises prioritizing said at least two applications in an order in accordance with information representative of a state of at least one of said applications.

27. A user interface according to claim 25, wherein said representation is a signal to be displayed.

28. A user interface according to claim 25, comprising a display for displaying said representation.

29. A user interface according to claim 25, wherein a plurality of representations is displayed.

30. A user interface according to claim 25, wherein said one representation comprises a user interface element.

31. A user interface according to claim 30, wherein said displayed user interface element comprises at least one icon associated with an application.

32. A user interface according to claim 30, wherein said displayed user interface element comprises an element indicating at least one application.

33. A user interface according to claim 30, wherein said displayed user interface element comprises a button.

34. A user interface according to claim 30, wherein said displayed user interface element comprises a tray.

35. A user interface according to claim 25, wherein said user interface element is composed of a plurality of representations.

36. An electronic device having a display and being adapted to operate a plurality of applications, comprising:
a component for providing a representation of one of said applications;
a component for using said representation to present information of at least one other of said applications;
a component for selecting one of said applications for direct display and selecting at least another of said applications for indirect display in accordance with information representative of a state of at least one of said applications.

37. An electronic device according to claim 36, further comprising a component prioritizing said at least two applications in an order in accordance with information representative of a state of at least one of said applications.

38. An electronic device according to claim 37, further comprising a component for receiving an indication of at least one application, said indication comprising information representative of a state of at least one of said applications and a component for providing a representation of said application for display, according to said information representative of a state of at least one of said applications.

39. An electronic device according to claim 36, further comprising an input device and a component to display said generated representation as a user interface element.
